(19) United States
(12) Patent Application Publication
(10) Pub. No.: US 2013/0104470 A1
(43) Pub. Date: May 2, 2013

(54) Fire-Protection or Smoke-Protection Device

(71) Applicants: Merlin Mueller, Goslar (DE); Daniel Reinhart, Maroldsweisach (DE); Jochen Stoebich, Langelsheim (DE)

(72) Inventors: Merlin Mueller, Goslar (DE); Daniel Reinhart, Maroldsweisach (DE); Jochen Stoebich, Langelsheim (DE)

(21) Appl. No.: 13/639,614

(22) PCT Filed: Apr. 7, 2011
(86) PCT No.: PCT/EP11/01722

§ 371 Date: Jan. 9, 2013

(30) Foreign Application Priority Data
Apr. 9, 2010 (DE) 10201001446069

(51) Int. Cl. A62C 2/10; E04B 1/94

(52) U.S. Cl. CPC A62C 2/10; E04B 1/941
USPC 52/173.1; 169/48

(57) ABSTRACT

A fire or smoke protection device for an opening (12) in building section (14), in particular a gateway, with a flexible, flat fire protection element (16) which can be put into a storage arrangement, in which the fire protection element (16) is folded along creases (18), and a sealing arrangement, in which the fire protection element (16) is unfolded and seals the opening (12), the fire protection element (16) comprising at least one indentation (32) on one side, by means of which the building section (14) can be at least partially surrounded for guiding the fire protection element (16).

The invention relates to a fire or smoke protection device for an opening in building section, in particular a gateway with a flexible, flat fire protection element which can be put into a storage arrangement, in which the fire protection is folded along creases, and into a sealing arrangement, in which the fire protection element is unfolded and seals the opening.

This type of fire or smoke protection element is used to seal openings, such as gateways, passageways or doorways, from fire and/or smoke in the event of a fire in order to prevent it from spreading.

A fire protection system is described in DE 196 31 961 A1, whereby inflatable sacks made from fire resistant textile material are inflated in the event of fire and thus seal openings. The disadvantage of these fire protection systems is that a gas source must be available at all times in order to inflate the sacks in the event of a fire. As gas cylinders are used for this purpose, this presents a danger. Similar solutions are described in EP 0 819 447 B1 and EP 0 848 967 B1.

A fire or smoke protection device is described in U.S. Pat. No. 3,729,043 which is guided by lateral guides and, in the event of a fire, is lowered into these guides in order to seal an opening. The disadvantage of this solution is that guides must be available at all times, which limits architects' design freedom. Furthermore, guides can become dirty and therefore must be checked and cleaned regularly.

A fire and smoke barrier for rail vehicles is described in EP 1 249 255 A1 which comprises a fire resistant textile material arranged about a front end passageway of the rail vehicle. In the event of a fire, the fire resistant textile material seals off the passageway on all sides. The disadvantage is that this type of solution is not well suited for buildings, as the area of opening to be protected must be fully covered with the fire resistant textile material.

A fire protection curtain is described in EP 1 964 593 A1 which has a track in front of the fire resistant textile material comprising openings, through which convection occurs in the event of a fire. However, the fire resistant curtain always requires a winding shaft.

The invention aims to improve the fire protective effect and/or to facilitate the construction of the fire or smoke protection device with the same fire or smoke protective effect.

The invention solves the problem by means of a fire or smoke protection device according to the preamble, the fire protection element comprising at least one indentation on one side, by means of which the building section can be at least partially surrounded for guiding the fire protection element.

The invention is advantageous because it is easily constructed. It is therefore only necessary to mount the fire or smoke protection device above the opening which should be sealed in the event of a fire. In the event of a fire, a mounting device is automatically or manually released, so that the fire protection element comes down, preferably through weight alone, and thus seals the opening. As a result of the downward movement, the fire protection element is guided by the indentation to the building section, for example a wall, so that differences in pressure on both sides of the fire protection element do not cause it to be excessively deflected.

A further advantage is that the fire or smoke protection device can be designed to be especially flat, as the fire protection element can be stored folded up.

Within the scope of the above description, the term fire or smoke protection covering should be understood to mean any device which is designed to prevent or impede the spread of fires for a long time, or to prevent the spread of smoke produced by a fire. These types of fire or smoke protection coverings must withstand a fire for at least 30 or 60 minutes, for example, and are therefore fundamentally different to devices which are only suitable for the sealing of openings.

In particular, the flat fire protection element has a tube-like form and can be folded up along its creases like an accordion. In other words, the fire protection element can be folded along the creases and is done so in the sealing arrangement.

In a preferred embodiment, the fire protection element comprises a fire resistant textile material. This type of fire resistant textile material refers in particular to a woven fabric, a non-woven fabric or a knitted fabric that is non-flammable and withstands high temperatures for a sufficiently long time in order to prevent flames and/or smoke from entering for at least 30 minutes. These types of fire resistant textile materials belong to the prior art and will therefore not be described in more detail. An advantage of using fire resistant textile materials is the low manufacturing cost. As a result, it is possible to make the fire protection element from one, two, three or more flat pieces of fire resistant textile material by sewing them together. Due to the simple construction, a fire protection element made with fire resistant textile material is robust and less susceptible to faults. This leads to a more reliable functioning, even after longer periods of inactivity.

According to a preferred embodiment, when it is in the sealing arrangement, the fire protection element tapers downwards conically at least in sections. It is particularly favourable if the fire protection element tapers conically downwards completely when it is in the sealing arrangement. This results in a space-saving storage arrangement, as sections of the fire protection element situated further down can be arranged into sections of the fire protection element situated further towards the top.

According to a preferred embodiment, when in the storage arrangement, the fire protection element has sections separated by creases which are at least partially packed into one another in the sealing arrangement. This results in an especially compact storage arrangement. This, in turn, has the advantage that the height of the opening is only marginally altered by the fire or smoke protection device. The sections can, for example, be arranged between every second crease throughout the area in question.

The term sections generally refers to units of an entire fire protection element, in particular an entire fire resistant textile material. However, it is also possible that the fire protection element is made up of several pre-prepared sections that are joined together.

When in the sealing arrangement, the fire protection element preferably has a horizontal cross-section that has two parallel long sides. The indentations are located on the narrow sides. When in the storage arrangement, at least a number of the long sides run parallel to one another and at least partially at the same height.

According to a preferred embodiment, the fire protection element is designed in such a way that it can be moved from the storage arrangement into the sealing arrangement by gravity alone. This should be understood to mean that the energy required to put the fire protection element into the sealing arrangement is obtained from potential energy.

In particular, the fire protection element is designed in such a way that a predominant amount of the energy required for sealing comes from potential energy of the fire protection element itself. In this case, it is sufficient to release a mounting device by means of which the fire protection element is held in the storage arrangement. Driven by gravity, the fire protection element then moves itself into the sealing arrangement. Motors are unnecessary, making the fire or smoke protection device particularly robust and easy to maintain.

The fire or smoke protection device preferably comprises a base plate that is attached at the bottom of the fire protection element. The weight of the base plate is preferably so large that, when in the storage arrangement, the fire protection element falls into the sealing arrangement, due to the force of gravity, following the release of the mounting device.

In a building according to the invention, the underside of the base plate is preferably a visible surface which corresponds to the surrounding area of the fire or smoke protection device. It is possible, although not necessary, that the base plate has a contact strip by means of which a collision, for example with a person, can be detected.

The fire protection element is preferably part of a closed shell of an interior, the shell having at least one opening with an opening cross-section, the opening being arranged in such a way that when the fire protection element is moved from the storage arrangement into the sealing arrangement, air flows through the shell in the interior and a flow resistance occurs. The opening cross-section has been selected to be so small that the flow resistance delays a movement of the fire protection element from the storage arrangement into the sealing arrangement.

The fact that the fire protection element is part of the closed shell should be understood to mean that the interior of the fire protection element is largely gas proof. The fact that the closing is largely gas proof should be understood particularly to mean that a gas flow, resulting from a difference in pressure of 50 Pa across the fire protection element, is smaller than 150, in particular 50 cubic meters per hour.

It is possible, but not necessary, that the openings refer to inserted, macroscopic openings. It is also possible that the fire protection element has a certain porosity, so that air flows through the pores when the fire protection element is moved from the storage arrangement into the sealing arrangement. In this case, openings are unnecessary. However, the fire protection element is preferably essentially gas proof and comprises openings, for example slots.

It is especially preferable if the opening cross section has been selected to be so small that the flow resistance the sealing time of the protection element is at least doubled in comparison to an otherwise structurally comparable fire or smoke protection device whose openings have a cross section that is 10 times as big. Limiting the sealing speed in this way is constructionally simple and simultaneously stable.

According to a preferred embodiment, the shell has at least one upper opening facing the fire, one lower opening facing the fire, one upper opening facing away from the fire and one lower opening facing away from the fire, the openings facing away from the fire being designed in such a way that a convection current forms through the lower opening facing away from the fire, the interior and the upper opening facing away from the fire. This type of convection current cools the fire protection element and thus extends the protection time of the fire or smoke protection device. According to the invention, a fire or smoke protection device is additionally for an opening in a building section, in particular a closing in a gateway with (a) a flexible, flat fire protection element that can be put into a storage arrangement, in which the fire protection element is folded along creases, and a sealing arrangement, in which the fire protection element is unfolded and seals the opening, the fire protection element being part of a closed shell of an interior. The shell has at least one upper opening facing the fire, one lower opening facing the fire, one upper opening facing away from the fire and one lower opening facing away from the fire, the openings facing away from the fire being designed in such a way that, in the event of a fire, a convection current forms through the lower opening facing away from the fire, the interior and the upper opening facing away from the fire.

It is particularly preferable if the fire or smoke protection device comprises a sealing instrument that is designed to seal the opening facing the fire under the influence of heat. This prevents hot gases generated from the fire penetrating the interior and endangering an object on the side facing away from the fire. The sealing instrument preferably refers to passive sealing instruments, i.e. sealing instruments which work without being dependent on a motor driven by an external energy supply. Passive sealing instruments such as this are simple and simultaneously stable.

At least one part of the sealing instrument preferably shows a phase transition under the influence of heat. For example, the sealing instrument may have an energy storing mechanism such as a spring, which is kept inactive by a solder that melts in the heat of a fire. In the event of a fire, the solder experiences a phase transition, namely that it melts and thereby releases the energy stored in the energy store. This energy causes the opening to be sealed, for example by closing a flap.

It is especially preferable if the sealing instrument comprises an intumescent material. This intumescent material can be arranged in such a way that the openings facing away from the fire swell and close in the event of a fire. This type of sealing instrument is simultaneously simple and stable.

The fire protection element preferably has a fire retardant coating. This may refer to a reflective coating, for example metallization. For example, an aluminum coating would be suitable.

Alternatively or additionally the coating, which can also be called a fire retardant surface, is insulating. In this way, the coating may be endothermic, meaning that it contains at least one substance that displays an endothermic reaction under the influence of heat. In this way the fire protection element is cooled in the event of a fire. The coating may also comprise intumescent material, so that the insulating effect greatly increases in the event of a fire.

According to a preferred embodiment, the fire or smoke protection device comprises a sealing instrument that is designed to seal the opening facing the fire, the sealing instrument comprising fabric elements: one fabric element is arranged facing outwards on at least one upper opening and one fabric element is arranged facing the interior on at least one lower opening, so that in the event of a fire a convection current forms through the lower opening facing away from the fire, the interior and the upper opening facing away from the fire and a gas current from the side of the fire is blocked from going through the upper opening facing the fire, the interior and the lower opening facing the fire. Here, the fabric elements act as diaphragm valves.

According to a preferred embodiment, the fire or smoke protection device comprises a gas generator that is designed to emit an inert and/or cooling gas into the interior of the fire protection element in the event of a fire. This gas generator may refer to a passive gas generator, for example a coating or a surface, that emits a gas in the event of a fire. This gas may, for example, come from a chemical reaction or the evaporation of a substance, particularly water. As a result of the gas being emitted into the interior, the pressure in the interior increases, which improves the sealing of the fire or smoke protection device to surrounding building components.

The fire or smoke protection device preferably has at least one layer of fire resistant textile material in the interior. This layer of fire resistant textile material is vertical when in the sealing arrangement. This fire resistant textile material can be designed to insulate heat and/or block radiation. For this purpose it may have a coating such as the one described above. As the layer is arranged in the interior and thus surrounded by the fire protection element and therefore protected, less is required of the mechanical strength of the coating, producing an easily manufactured fire or smoke protection device with a high fire resistance effect. The layer may form a vertical parting plane, creating at least two cavities in the interior.

It is possible that the gas generator is located in a base plate, a top panel or on the fire protection element. The fire or smoke protection device is preferably designed in such a way that the interior is constantly filled with gas only, as well as in the event of a fire. This allows the fire or smoke protection device to be easily removed so that rescue operations are not obstructed.

The fire protection element is preferably made up of at least two segments that are arranged next to each other and connected to each other by flexible connectors, in particular cables. This facilitates the installation of wider fire or smoke protection devices.

The cables can be fixed onto the fire protection element with eyelets, straps or brackets, for example. In other words, the connectors can function as power transmission elements to a motor. It is particularly favourable, for example, if the cables are also designed to hold the flat fire protection element in the storage arrangement.

It is possible that the connectors are connected to a braking device which restricts a movement of the fire protection element into the sealing arrangement. However, alternatively or additionally, the connector may also be connected to the fire protection element in such a way that the friction between the two restricts a movement of the fire protection element into the sealing arrangement.

It is favourable if the fire or smoke protection device has a pre-loading device that is designed to keep the connectors tense so that the shell is stabilized. As a result, reinforcements are at least partially unnecessary.

The fire or smoke protection device preferably comprises a number of reinforcement elements which are each arranged in creases and define the horizontal cross-section of the fire protection element. For this purpose the reinforcement elements run in curves on a horizontal level. In particular, the reinforcement elements are in the form of a curve with at least one indentation to contain the building section.

It is favourable if the reinforcement elements are designed in such a way that they cause the fire protection element to always fold along the same creases. The reinforcement elements then act as a means of forcing the element to fold along specific lines.

The fire or smoke protection device is preferably free of guide rails, in terms of a side conduct. This means that on both sides indentations are available, which represent the individual conducting elements. However, it is possible that a guide rail is available, which increases the smoke-proofing function of the fire and smoke protection device.

According to a preferred embodiment, the fire and smoke protection device comprises a first cavity and at least a second cavity, with an indentation designed to be located between the two cavities. The cavities preferably extend across slightly more than the clear width of the building opening so that they lie closely on the building section on both sides. Between the first cavity and the second cavity there may be a distance that corresponds to the thickness of a wall in the building section in which the opening is arranged.

It is possible that more than two cavities are available. In this way, a third cavity can be made available between the two cavities mentioned above, whose width is, at the most, the same as the clear width of the opening, particularly the building opening. For example, the third cavity may comprise intumescent material and/or material that has a physical and/or chemical endothermic reaction under the influence of heat.

A flexible partition element made from a fire resistant textile material is preferably arranged between the first cavity and the second cavity. It is possible that the first cavity is constructed symmetrically to the second cavity, in terms of the level at which the partition element is arranged.

It is favourable if the cavities are mechanically connected by connecting elements. The connecting elements are preferably flexible. For a particularly high impermeability, the connecting elements between cavities may exert a tractive force if the fire protection element is in the sealing arrangement.

If connecting elements are available, they are preferably arranged in such a way that they connect the first cavity and at least a second cavity so that the cavities are fixed relative to one another relative to the building section, at least with respect to a movement in the direction of a perpendicular on the surface of the building opening. In other words, the connecting elements ensure that the building section is surrounded, and that the first cavity from one side and the other cavity from the opposite side of the building opening both lie closely on the building section. The fire and smoke protection device then also remains fixed relative to the building opening when there is a difference in pressure across the building opening.

The first cavity and the at least second cavity are preferably separated from one another with regards to an air current. In other words, a difference in pressure across the building opening, for example between the two rooms separated by the building opening, does not lead to a significant air current from one side of the building opening, first of all into the first cavity, then in the second cavity and later to the other side of the building opening.

The first cavity preferably comprises a first fire resistant textile material which surrounds a first interior in at least two directions, the second cavity preferably comprising a second fire resistant textile material which surrounds a second interior in at least two directions. In particular, the first fire resistant textile material and/or the second fire resistant textile material form a tube which, for example, may have an elongated square cross-section.

It is possible that the cross-section tapers off downwards in the sealing arrangement. The interior must not to be surrounded on all sides by the fire resistant textile materials. In this way it is possible that one part of the upper border of the interiors is formed by another component of the fire or smoke protection device, for example by a suspension device with which the fire or smoke protection device can be fixed onto a building section.

According to a preferred embodiment, the first cavity has an upper opening facing the fire and/or a lower opening facing the fire. Alternatively or additionally it is possible that the second cavity has an upper opening facing away from the fire and/or a lower opening facing away from the fire. Of course, each cavity may have more than one opening. In the event of a fire, a convection current forms through the lower opening facing away from the fire, the second interior and the upper opening facing away from the fire, so that the second cavity facing away from the fire is cooled by the convection current. This extends the service life of the fire and smoke protection device.

According to a preferred embodiment, the fire or smoke protection device has a suspension device to fix it to a building section, in particular to the roof or wall of a building, the suspension device comprising at least one upper opening. One part of the suspension device may be a component of the first cavity or the second cavity. In other words, it is possible, for example, that the lower opening facing the fire is found in the fire resistant textile material of the fire protection element, whereas the upper opening facing the fire is found in the suspension device. Alternatively or additionally, the lower opening facing away from the fire may be found in the fire resistant textile material of the fire protection element and the upper opening facing away from the fire in the suspension device.

The flexible, flat fire protection element preferably comprises a wire mesh. These types of wire meshes cause a greater resistance of the fire and smoke protection device under the influence of heat.

The flexible, flat fire protection element is preferably folded in the storage arrangement. In this case, the term fold should be understood to mean a fold in irregularly located creases.

In addition, according to the invention, a fire or smoke protection device for an opening is in a building section, in particular the closing to a gateway, with a flexible, flat fire protection element that can be put into a storage arrangement, in which the fire protection element is folded along creases, and a sealing arrangement, in which the fire protection element is unfolded and the opening is sealed, the fire and smoke protection device comprising a base tray that has active cooling and/or ventilation elements.

In the following, the invention will be explained in more detail with the aid of an example. What is shown is:

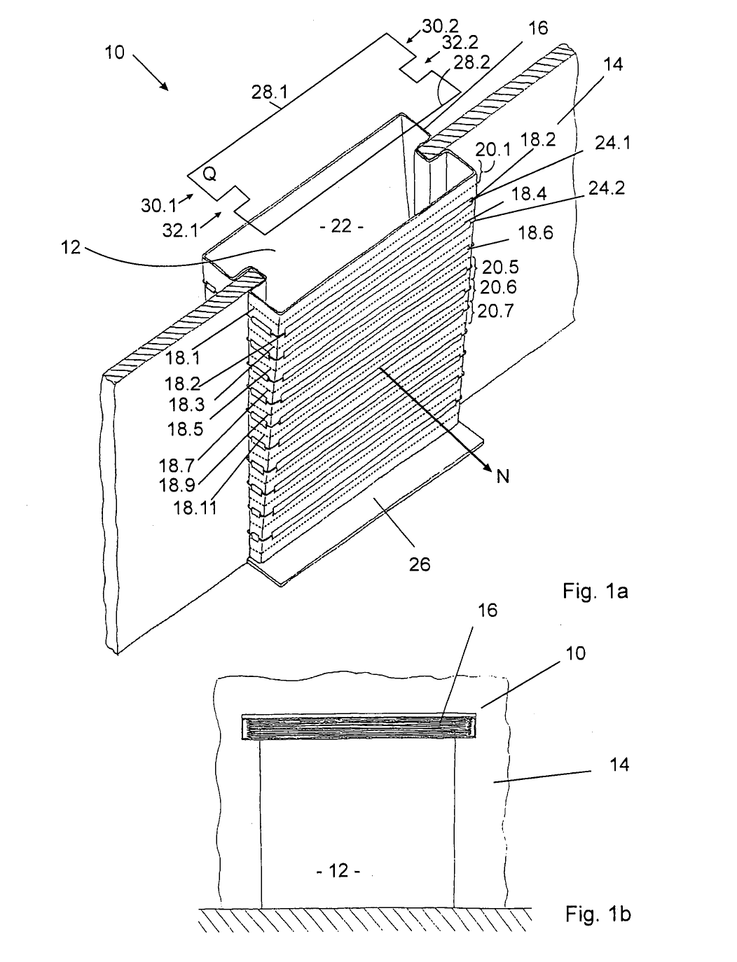

FIG. 1a a perspective view of a fire or smoke protection device according to the invention in a building according to the invention;

FIG. 1b a side view of the fire and smoke protection device according to FIG. 1a;

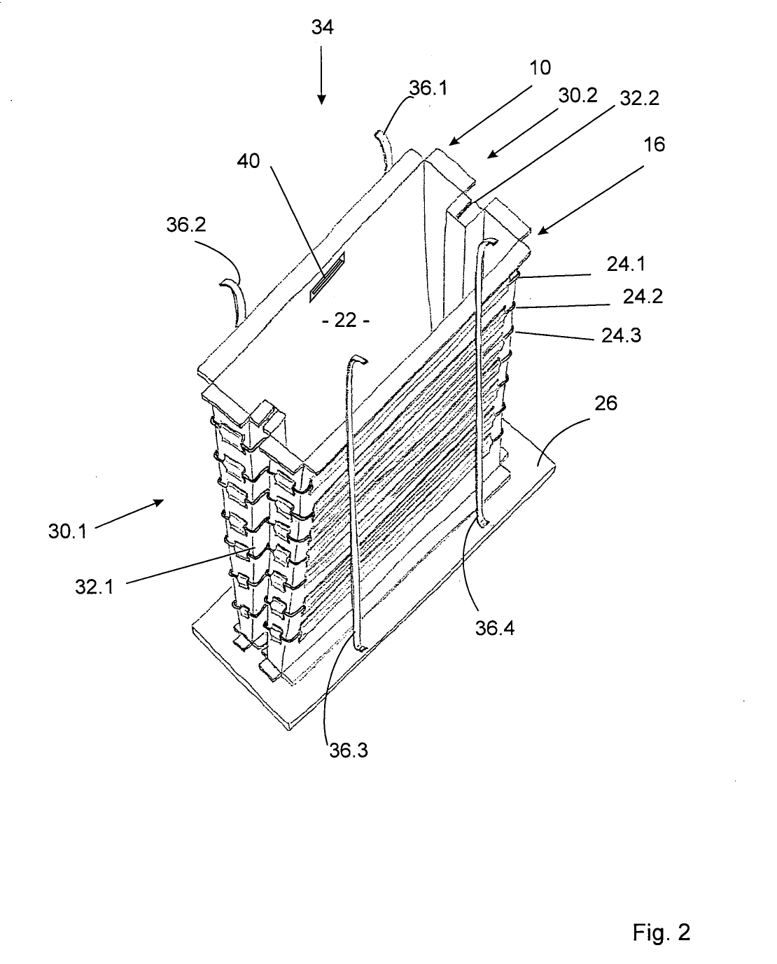

FIG. 2 the fire and smoke protection device according to FIGS. 1a, 1b without the building section in which the opening to be sealed is found;

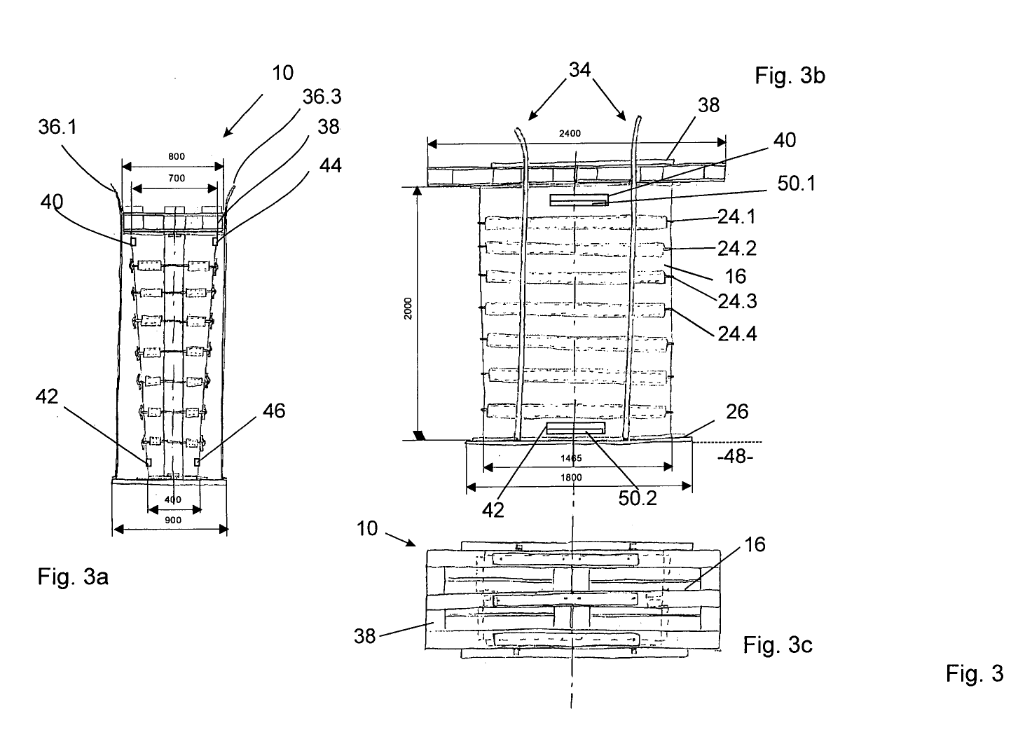

FIG. 3 side views, with their section FIGS. 3a, 3b and 3c, of the fire and smoke protection device according to FIGS. 1 and 2;

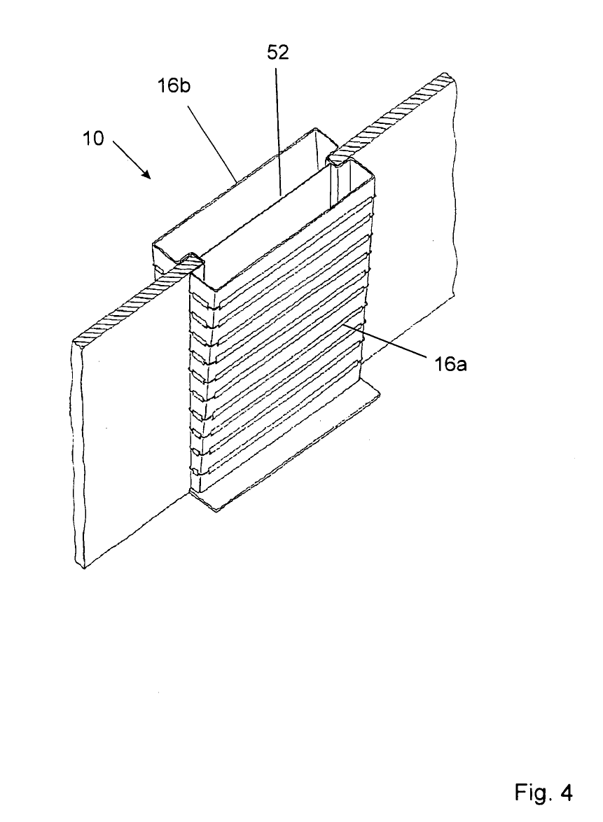

FIG. 4 a perspective view of a fire or smoke protection device according to the invention, according to a preferred embodiment; and

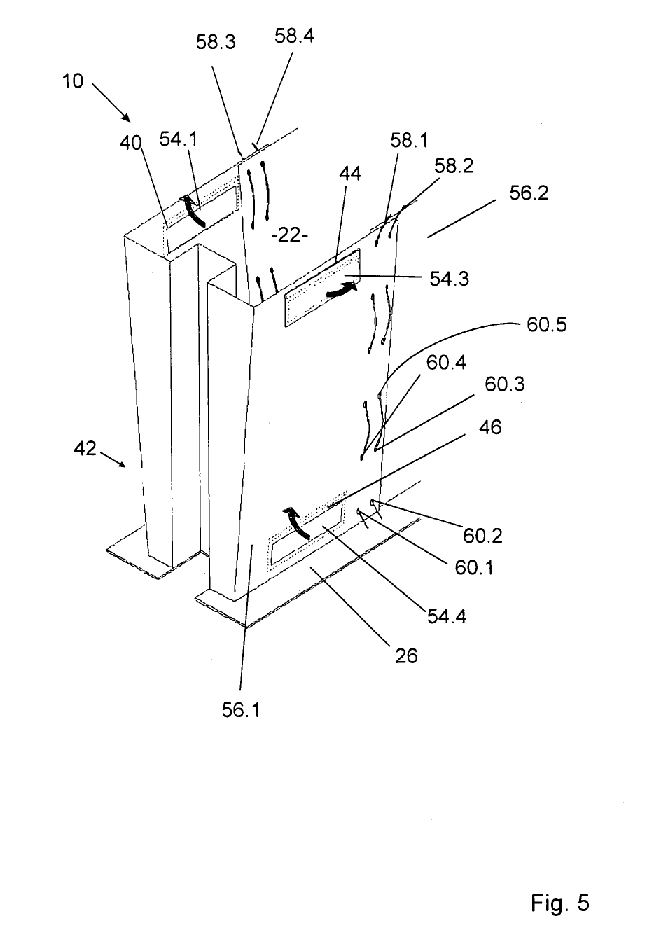

FIG. 5 a perspective section view of a fire or smoke protection device according to the invention, according to a further preferred embodiment.

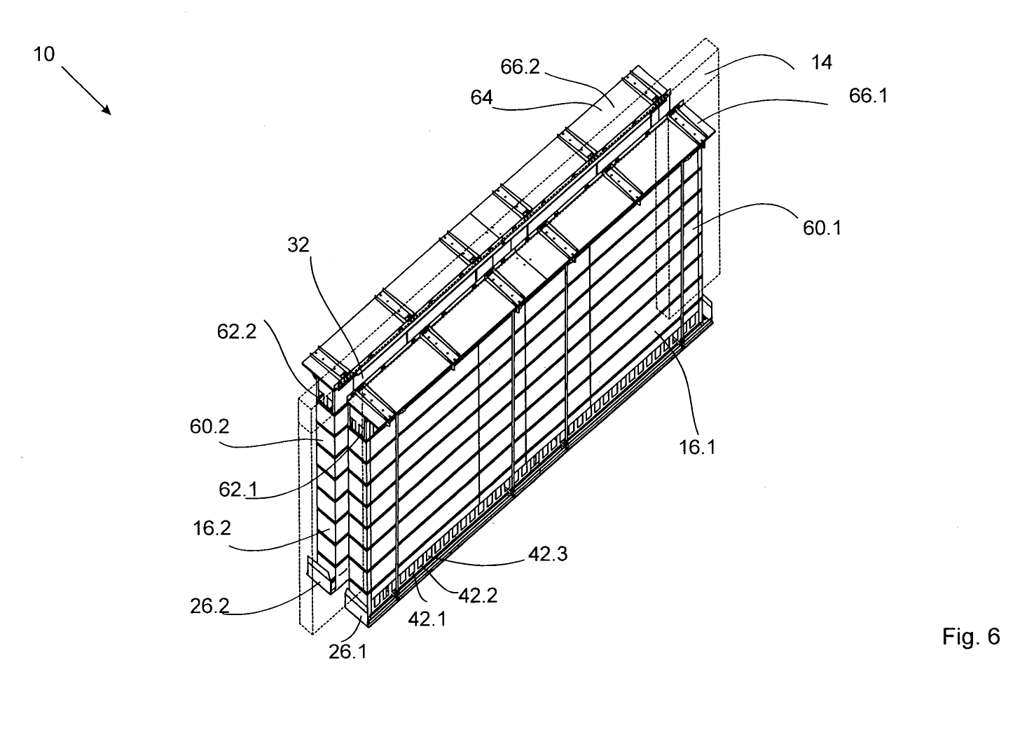

FIG. 6 shows a perspective view of a fire and smoke protection device with two cavities, between which the indentation is found and

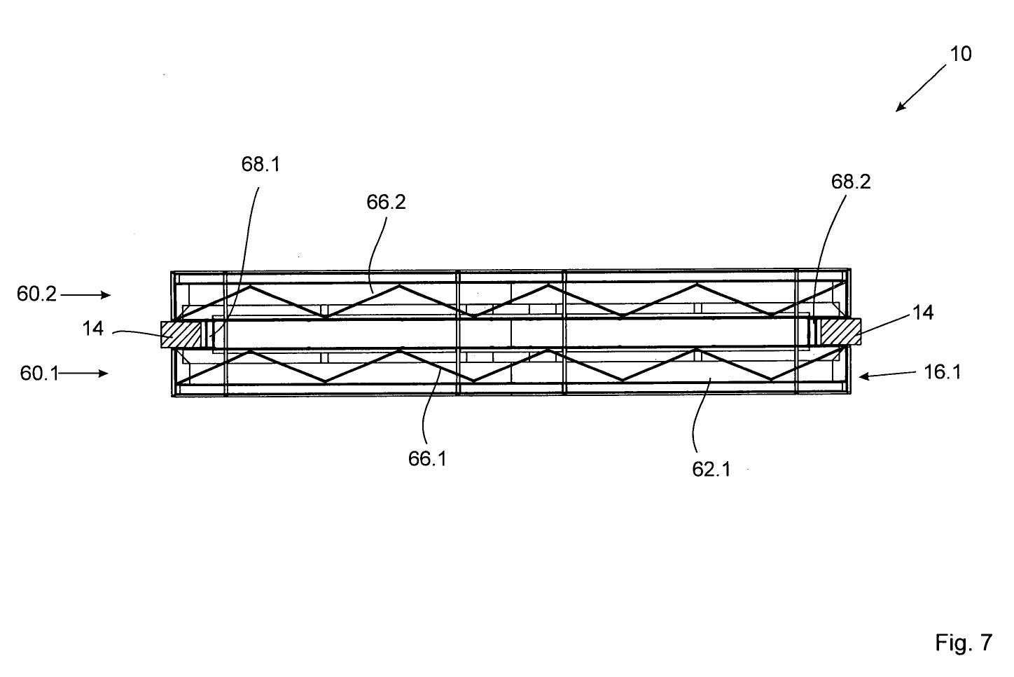

FIG. 7 is a cross-section through FIG. 6, with respect to a horizontal sectional plane.

FIG. 1 shows a fire or smoke protection device 10 according to the invention for an opening 12 in a building section 14 in the form of a wall. The fire or smoke protection device 10 has a flexible, flat fire protection element 16 in the form of a fire resistant textile material that is shown in its sealing arrangement in FIG. 1, in which the fire protection element 16 seals the opening 12.

The fire protection element 16 in the form of the fire resistant textile material has a number of creases, 18.1, 18.2, . . . , along which the fire protection element 16 can be folded. Should the fire protection element 16 be put into its storage arrangement, shown in FIG. 1b, it bends in a convex manner along the creases 18.2, 18.4, 18.6, . . . , and in a concave manner along the creases 18.1, 18.3, 18.5, . . . . Here, the creases 18.1, 18.3, 18.5, . . . move into an interior 22 that has a lateral border with the fire protection element 16. In the following, reference signs without counting suffix indicate the object as such.

Between every two creases, 18.1, 18.3, 18.5, a planned section 20 is found, for example between the creases 18.7 and 18.9 is section 20.5, between the creases 18.9 and 18.11 is section 20.6 and so forth. In the storage arrangement, some of the sections lie at least partially in other sections, for example the section 20.6 may be partially arranged in section 20.5, resulting in a compact storage arrangement.

A strut 24 is fixed in every second crease 18.2, 18.4, 18.6, . . . . In this way, the strut 24.1 is fixed in the crease 18.2, strut 24.2 in crease 18.4 and so forth. The struts 24 are formed from poles, for example metal poles, and they reinforce the fire protection element 16.

The fire or smoke protection device 10 has a base plate 26 that is fixed to a lower end of the fire protection element. A base plate weight G₂₆ is selected in such a way that it pulls the fire protection element 16 out of the storage arrangement shown in FIG. 1b into the sealing arrangement shown in FIG. 1a, when the base plate 26 is not held by a mounting device.

The fire protection element 16 has a cross-section Q with two long sides 28.1, 28.2 and these two long sides 28 connect transverse sides 30.1, 30.2. An indentation 32.1, 32.2 is found in each of the transverse sides 32.1, 32.2. The indentations 32 are formed in such a way that the building section 14, in the above case the wall, in which the opening 12 is found, is surrounded so as to guide the fire protection element 16. The indentations 32 are formed in such a way that forces are exerted on the fire protection element 16 in the building section 14 in a normal direction N of a perpendicular.

The building protection element 16 tapers conically downwards. In other words, the distance between the two long sides 28.1, 28.2 becomes smaller the further down the cross-section Q you look.

FIG. 1b shows the fire or smoke protection device 10 with the fire protection element 16 in the storage arrangement. It should be recognized that the opening 12 of the building section 14 is unsealed. A gateway is not depicted, with which the opening can be reversibly sealed and returned to normal operation.

FIG. 2 shows a perspective view of the fire or smoke protection device 10. It should be recognized that the smoke protection element 16 has the indentations 32.1, 32.2 on the transverse sides 30.1, 30.2. The struts 24.1, 24.2, . . . run completely around the periphery of the cross-section Q and therefore also in the area of the indentations. The struts 24 are fixed to a fire resistant textile material with sewed on or woven straps, respectively.

The base plate 26 is fixed to a top plate 38 (FIG. 3b) by a mounting device 34 that has four straps 36.1, 36.2, 36.3, 36.4: these hold the base plate in place in the storage arrangement. By releasing the mounting device 34 by means of a release device, not depicted here, the weight G₂₆ of the base plate 26 and the weight of the fire protection element 16 pull it into the sealing arrangement.

FIG. 2 shows that the fire protection element 16 is part of a shell of the interior 22. The base plate 26, which is connected to the fire protection element 16 by a seal, is also included in this shell. In addition, FIG. 2 shows a schematic of an upper opening 40 facing the fire that has an opening cross-section Q₄₀ and is slit-shaped. When moved from the storage arrangement into the sealing arrangement, air flows through the upper opening facing the fire 40 and thus experiences a flow resistance. As a result, a vacuum occurs in the interior 22 which slows down the fire protection element 16 when moving into the sealing arrangement.

FIG. 3a shows a schematic of the upper opening facing the fire 40, a lower opening facing the fire 42, an upper opening facing away from the fire 44 and a lower opening facing away from the fire 46. Of course, it is fundamentally unknown on which side of the fire or smoke protection device 10 a fire will break out. The terms “facing away from the fire” and “facing the fire” are therefore only terms to indicate one of the two sides of the fire or smoke protection device.

It is possible that the fire or smoke protection device 10 has openings on one side only, for example if it is guaranteed that a fire can only occur on one side. The upper opening facing the fire 40 and the lower opening facing the fire 42 form a connection between the interior 22 and the surrounding area of the fire or smoke protection device 10. In the event of a fire, the interior 22 warms up and a cooling air current forms through the lower opening facing the fire 42, the interior 22 and out of the upper opening facing the fire 40 into the surrounding area, which cools the interior 22.

FIG. 3b shows that the fire protection element 16, that may also be called a folding sack due to its shape, is fixed to the top plate 38 so that it is airtight. The top plate 38 is part of the sealed shell of the interior 22. If the fire protection element 16 moves into the sealing arrangement shown in FIG. 3b, air can only flow into the interior 22 through the openings 40, 42, 44, 46 and experiences a flow resistance as it flows through the respective cross-sections of the openings.

As a result of this flow resistance, a sealing time T_{close} extends from the moment of the release of the mounting device 34 to the moment when the base plate 26 comes into contact with an ground 48 to at least double the sealing time that the fire or smoke protection device would have if, rather than the top plate 38, a frame was available, through which substances could flow freely. A suitable size for the openings 40, 42, 44, 46 can be established in preliminary experiments in which the openings can be enlarged successively and the sealing times T_{close} defined respectively. As soon as the desired sealing time is achieved, the size of the openings is no longer adjusted.

FIG. 3b shows a schematic of a first sealing instrument 50.1 and a second sealing instrument 50.2 in the form of an elongated intumescent element. In the event of a fire, the intumescent material swells up and seals the openings facing the fire 40, 42 only, but not the openings facing away from the fire 44, 46. In this way, the chimney effect described above can take place through the openings facing away from the fire 44, 46, whereas a hot air current is prevented from flowing through the openings facing the fire 40, 42.

FIG. 3c shows a view from above onto the fire or smoke protection device 10. It should be recognized that the top plate 38 comprises slits. In this case, the top plate 38 is fixed as tightly as possible to a ceiling of the building, not depicted here, so that an air current through the top plate 38 is insignificantly small in comparison to an air current through the openings 40, 42, 44, 46.

In FIGS. 3a and 3b, dimensions are shown which belong to a preferred embodiment and are realized in millimeters. Of course, other dimensions are possible.

FIG. 4 shows a fire or smoke protection device 10 according to the invention that has a layer 52 of fire resistant textile material in the interior 22. The layer 52 may also be referred to as a partition element and forms a partition level between a first fire resistant textile material 16a and a second fire resistant textile material 16b of the fire resistant textile material 16.

The layer 52 can insulate heat and/or block radiation and, in addition comprises a coating, which can also be called a fire retardant surface. The coating can thus be endothermic, meaning that it contains at least one substance that displays an endothermic reaction under the influence of heat. In this way, the fire protection element is cooled in the event of a fire. The coating may also comprise intumescent material, so that the insulating effect greatly increases in the event of a fire.

FIG. 5 shows a fire or smoke protection device 10 with a sealing instrument that comprises fabric elements 54.1, 54.2, 54.3, 54.4 (not visible) made from fire resistant textile material which covers the openings 40, 42, 44 and 46 (not visible). The fabric elements 54.1, 54.3 are arranged facing outwards on the upper openings 40, 44. The fabric elements 54.2, 54.4 are arranged facing inwards on the lower openings 42, 46.

In the event of a fire, a convection air flow forms on the side facing away from the fire, going through lower opening facing away from the fire 46, the interior 22 and the upper opening facing way from the fire 44, as the air in the interior 22 warms up. However, a gas current from the side of the fire is blocked from going through the upper opening facing the fire 40, the interior 22 and the lower opening facing the fire 46, because the fire leads to too much pressure on the upper opening 40 and the fabric element 54.1 seals the opening 40.

In addition, FIG. 5 shows that the fire protection element 16 is made up of a first segment 56.1 and a second segment 56.2 that are arranged next to each and connected by flexible connectors 58.1, 58.2, 58.3, 58.4 in the form of cables. The segments 56.1, 56.2 overlap one another. The connectors 58 are predominantly led through eyelets 60.1, 60.2, . . . in the segments 56.1, 56.2 and fixed to the base plate 26. The friction of the connectors 58 in the eyelets causes a breaking of a downward motion of the base plate 26. At the ends facing away from the best plate 26, at least some of the connectors 58 are fixed with a support instrument, not depicted here, so that a downward motion of the base plate can be prevented.

FIG. 6 shows a fire or smoke protection device 10 according to the invention with a first cavity 60.1 and a second cavity 60.2, between which the indentation 32 is found in the form of a slit. The first cavity 60.1 comprises a first partial fire protection element 16.1 in the form of a fire resistant textile material that surrounds a first interior 62.1. The second cavity 60.2 comprises a second partial fire protection material 16.2 that surrounds a second space 62.2. The two cavities 60.1, 60.2 are mechanically connected with one another by connecting elements, which are not visible in FIG. 6, yet separated from one another in terms of an air current.

The fire or smoke protection device 10 has a suspension device 64, by means of which the fire or smoke protection device 10 is fixed onto the building section 14. In the above case, the suspension device 64 is made up of two parts 66.1, 66.2 that are fixed, for example with screws, separately from one another on opposite sides of the building section 14. The base plate 26 is made up of two parts and comprises two partial base plates 26.1, 26.2.

It should be recognized that the first cavity 60.1 has lower openings 42.1, 42.2, 42.3, . . . facing the fire, which are arranged adjacent to the partial base plate 26.1.

Alternatively, it is also possible that the lower openings facing the fire 42 are at least partially found in the partial base plate 26.1.

Not visible in FIG. 6 are lower openings facing away from the fire 46 in the second fire protection element 16.2, as well as upper openings 40 in the first fire protection element 16.1, which are covered by the first part 66.1 of the suspension device 64. In the above embodiment, the second fire protection element 16.2 has upper openings facing away from the fire 44, which are also not visible.

FIG. 7 shows a cross-section through a fire or smoke protection device 10 according to FIG. 6. It should be recognized that the first fire protection element 16.1 surrounds the interior 62.1 on four sides in such a way that it forms a square cross-section. Opposite sides of the first fire protection element 16.1 are fixed relative to one another by means of a stabilizing element 66.1. The second cavity 60.2 is constructed in the same way as the first cavity 60.1. Both cavities 60.1, 60.2 are connected to one another by connecting elements 68.1, 68.2. The cavities 60.1, 60.2 therefore always lie closely to the building section 14.

### REFERENCE LIST

| | |
|---|---|
| 10 | Fire or smoke protection device |
| 12 | Opening |
| 14 | Building section |
| 16 | Fire protection element |
| 18 | Crease |
| 20 | Sections |
| 22 | Interior |
| 24 | Strut |
| 26 | Base plate |
| 28 | Long sides |
| 30 | Transverse side |
| 32 | Indentation |
| 34 | Mounting device |
| 36 | Strap |
| 38 | Top plate |
| 40 | Upper opening facing the fire |
| 42 | Lower opening facing the fire |
| 44 | Upper opening facing away from the fire |
| 46 | Lower opening facing away from the fire |
| 48 | Ground |
| 50 | Sealing instrument |
| 52 | Layer |
| 54 | Fabric element |
| 56 | Segment |
| 58 | Connectors |
| 60 | Cavities |
| 62 | Interior |
| 64 | Suspension device |
| 66 | Stabilizing element |
| 68 | Connecting element |
| G₂₆ | Weight |
| Q | Cross-section |
| N | Normal direction |
| Q₄₀ | Opening cross-section |
| T_{close} | Sealing time |

1. A fire or smoke protection device for an opening (12) in a building section (14), particularly a gateway, with
(a) a flexible, flat fire protection element (16) which can be put
in a storage arrangement, in which the fire protection element (16) is folded along creases, and
in a sealing arrangement, in which the fire protection element (16) is unfolded and seals the opening (12),
characterized by the fact that
(b) the fire protection element (16) has an indentation (32) on at least one side, by means of which the building section (14) can be at least partially surrounded for guiding the fire protection element (16).

2. The fire or smoke protection device according to claim 1, characterized by the fact that the fire protection element (16) is a fire resistant textile material.

3. The fire or smoke protection device according to claim 1, characterized by the fact that the fire protection element (16) tapers downwards conically at least in sections when it is in the sealing arrangement.

4. The fire or smoke protection device according to claim 1, characterized by the fact that the fire protection element (16) has sections (20) separated by creases (18) when in the storage arrangement, which are at least partially arranged into one another in the sealing arrangement.

5. The fire or smoke protection device according to claim 1, characterized by the fact that the fire protection element (16) can be moved from the storage arrangement into the sealing arrangement by gravity alone.

6. The fire or smoke protection device according to claim 1, characterized by the fact that:
the fire protection element (16) is part of a closed shell of an interior (22),
the shell having at least one opening (12) with an opening cross-section (Q₄₀), the opening being arranged in such a way that when the fire protection element (16) is moved from the storage arrangement into the sealing arrangement, air flows in through the opening (12) into the interior and air flow resistance occurs,
the opening cross-section (Q₄₀) having been selected to be so small that the flow resistance delays a movement of the fire protection element (16) from the storage arrangement into the sealing arrangement.

7. The fire or smoke protection device according to claim 1, characterized by the fact that the opening cross section (Q₄₀) has been selected to be so small that the flow resistance at least doubles the sealing time (T_{close}) of the fire protection element (16).

8. The fire or smoke protection device according to claim 1, characterized by the fact that:
the fire protection element (16) is part of a closed shell of an interior (22),
the shell has at least
an upper opening facing the fire (40),
a lower opening facing the fire (42),
an upper opening facing away from the fire (44) and
a lower opening facing away from the fire (46), and
the openings facing away from the fire (44, 46) being designed in such a way that in the event of a fire, a convection current forms through the lower opening facing away from the fire (46), the interior (22) and the upper opening facing away from the fire (44).

9. The fire or smoke protection device according to claim 8, characterized by a sealing instrument (50) that is designed to seal the openings facing the fire (40, 42) under the influence of heat.

10. The fire or smoke protection device according to claim 1, characterized by a sealing instrument that is designed to seal the openings facing the fire (40, 42), the sealing instrument comprising fabric elements,
one fabric element being arranged facing outwards on at least one upper opening (40, 44) and
one fabric element being arranged facing the interior on at least one lower opening (42, 46), so that in the event of a fire a convection current forms through the lower opening facing away from the fire (46), the interior (22) and the upper opening facing away from the fire (46) and a gas current from the side of the fire is blocked from going through the upper opening facing the fire (40), the interior (22) and the lower opening facing the fire (46).

11. The fire or smoke protection device according to claim 1, characterized by a gas generator that is designed to emit an inert and/or cooling gas into the interior (22) of the fire protection element (16) in the event of a fire.

12. The fire or smoke protection device according to claim 1, characterized by at least one layer of fire resistant textile material in the interior (22).

13. The fire or smoke protection device according to claim 1, characterized by the fact that it is made up of at least two segments that are arranged next to each other and connected to each other by flexible connectors, in particular cables.

14. The fire or smoke protection device according to claim 1, characterized by a number of reinforcement elements (24) which are each arranged in creases (18) and define the horizontal cross-section of the fire protection element (16).

15. The fire or smoke protection device according to claim 1, characterized by
a. a first cavity (60.1) and
b. at least a second cavity (60.2),
c. the indentation (32) being found between the two cavities.

16. The fire or smoke protection device according to claim 1, characterized by the fact that the first cavity (60.1) and the second cavity (60.2) are connected by a connecting element in such a way that the cavities are fixed relative to one another relative to the building section (14), at least with respect to a movement in the direction of a perpendicular on the surface of the building opening.

17. The fire or smoke protection device according to claim 1, characterized by the fact that:
a. the first cavity (60.1) comprises a first fire resistant textile material which surrounds a first interior (62) on at least two sides, in particular on four sides, and/or
b. the second cavity (60.2) comprises a second fire resistant textile material which surrounds a second interior (62.2) on at least two sides, in particular on four sides.

18. The fire or smoke protection device according to claim 1, characterized by the fact that:
a. the first cavity (60.1) comprises the upper opening facing the fire (40) and/or the lower opening facing the fire (42),
and/or that
b. the second cavity (60.2) comprises the upper opening facing away from the fire and/or the lower opening facing away from the fire (46).

19. The fire or smoke protection device according to claim 1, characterized by:
a. a suspension device (64) for fixing it to a building section (14), in particular to the roof or wall of a building,
b. the suspension device (64) comprising at least one upper opening (40, 44)

20. The fire or smoke protection device according to claim 1, characterized by the fact that the flexible, flat fire protection element (16) comprises a wire mesh.

21. The fire or smoke protection device according to claim 1, characterized by the fact that the flexible, flat fire protection element (16) is folded when in the storage arrangement.

22. A building with
a. a building section (14), in which an opening (12) is found, and
b. a fire or smoke protection device (10) according to claim 1 whose indentation at least partially surrounds the building section (14) for guiding the fire protection element (16).
